(19) United States
(12) Patent Application Publication
(10) Pub. No.: US 2004/0064456 A1
(43) Pub. Date: Apr. 1, 2004

(54) Methods for data warehousing based on heterogenous databases

(76) Inventors: Joseph Shi Piu Fong, Hong Kong (HK); Qing Li, Hong Kong (HK)

Correspondence Address: INTELLECTUAL PROPERTY GROUP, FREDRIKSON & BYRON, P.A., 4000 PILLSBURY CENTER, 200 SOUTH SIXTH STREET, MINNEAPOLIS, MN, 55402, US

(21) Appl. No.: 10/259,208

(22) Filed: Sep. 27, 2002

(51) Int. Cl. G06F 17/00

(52) U.S. Cl. 707/100

(57) ABSTRACT

According to the present invention there is provided a method for establishing a data warehouse capable from a plurality of source databases including at least one relational database and at least one object-oriented database, comprising the steps of: integrating the schema of said plurality of source databases into a global schema, including resolving semantic conflicts between said source databases, and establishing a frame metadata model for describing data stored in said local databases, said frame metadata model including means for describing any constraints developed during schema integration and further including means for describing relationships between data stored in local object-oriented databases.

### FIELD OF THE INVENTION

The present invention relates to data warehousing methods and architectures, and in particular to such methods and architectures that enable a data warehouse to be constructed based upon heterogeneous legacy databases, and in particular both relational and object-oriented databases.

### BACKGROUND OF THE INVENTION

A data warehouse may be defined as a collection of information from various sources that an organization (normally though not necessarily a business) may wish to analyse in a read-only manner, for example to assist in management decisions and planning. Normally the data warehouse will consist of data from a number of different databases developed and used by different sub-units within the organization. The databases providing the source information for the data warehouse are known as legacy databases.

Since the legacy databases may have been developed over a number of years by different sub-units or branches within an organization, and may have been designed to meet particular objectives of the various sub-units and branches, one of the major challenges in the design and construction of a data warehouse is to be able to combine the data from heterogeneous legacy databases in a manner that can be accessed and analysed by a user.

### PRIOR ART

A known technique for multiple legacy databases of different forms into a usable data ware house is to use meta-data modeling techniques in which a common data schema, such as a star schema, is defined into which schema the data from the source databases may be applied. U.S. Pat. No.6,363,353 and U.S. Pat. No. 6,377,934 describe examples of such known techniques.

Particular difficulties arise, however, when the legacy databases are not only heterogeneous in their structures, but include both relational and object-oriented databases. In a relational database data is stored in tables that may be linked to each other using keys. By contrast, in an object-oriented database data is defined by classes and where an object in one class is related to another object the two objects point to one another and the nature of their relationship is also defined as a class. Both relational databases and object-oriented databases have their merits and in a large organization both types of database may exist for different applications.

An effective data warehouse must therefore be capable of integrating both relational and object-oriented databases, and furthermore should preferably be capable of presenting information to a user for analysis in either a relational or object-oriented manner.

### SUMMARY OF THE INVENTION

According to the present invention there is provided a method for establishing a data warehouse capable from a plurality of source databases including at least one relational database and at least one object-oriented database, comprising the steps of: integrating the schema of said plurality of source databases into a global schema, including resolving semantic conflicts between said source databases, and establishing a frame metadata model for describing data stored in said local databases, said frame metadata model including means for describing any constraints developed during schema integration and further including means for describing relationships between data stored in local object-oriented databases.

According to another aspect the present invention provides an architecture for a data warehouse comprising: a plurality of local databases including at least one relational database and at least one object-oriented database, a global schema formed from integrating the schema of said local databases, a frame metadata model for describing data in said local databases and for describing relationships between data in said at least one object oriented database and for describing any constraints derived during schema integration, a star schema for abstracting data from said local databases into a data cube for analysis, and means for querying said data cube.

According to a still further aspect the invention also provides a data warehouse comprising a plurality of local databases including at least one relational database and at least one object-oriented database, comprising: means for abstracting data from said local databases for analysis and means for querying said abstracted data, wherein said means for abstracting data is able to present said abstracted data for analysis in either relational or object-oriented views at the request of a user.

According to a still further aspect the invention also provides a method for integrating the schema of a plurality of local databases wherein said local database schemas are integrated in pairs, the integration of a pair of local database schemas including the resolving of semantic conflicts and merging of classes and relationships, and wherein a frame metadata model is established for describing the contents of said integrated local databases including any constraints established during said schema integration.

### BRIEF DESCRIPTION OF THE DRAWINGS

Some embodiments of the invention will now be described by way of example and with reference to the accompanying drawings, in which:-

FIG. 1 illustrates the concept of schema integration by cardinality,

FIG. 2 illustrates the concept of schema integration by superclass and sub-class,

FIG. 3 illustrates the concept of schema integration by generalization,

FIG. 4 illustrates the concept of schema integration by aggregation,

FIG. 5 illustrates in UML a recovered conceptual schema obtained through superclass/sub-class integration in an example of the invention,

FIG. 6 illustrates in UML a recovered conceptual schema obtained through generalization integration in an example of the invention,

FIG. 7 illustrates in UML a recovered conceptual schema obtained through cardinality integration in an example of the invention,

FIG. 8 illustrates in UML a recovered conceptual schema obtained through aggregation integration in an example of the invention,

FIG. 9 shows in UML the local database metadata schema in an embodiment of the invention,

FIG. 10 shows in UML the integrated database metadata schema in an embodiment of the invention,

FIG. 11 shows in UML a simple star schema for use in an embodiment of the invention,

FIG. 12 shows in UML the technical star schema metadata with datacube for use in an embodiment of the invention,

FIG. 13 illustrates for relationship between the frame metadata model, the global schema and the star schema of an embodiment of the present invention,

FIG. 14 illustrates the process of data integration to form a data cube in an embodiment of the invention,

FIG. 15 shows schematically an object-oriented view in online analytical processing in an embodiment of the invention,

FIG. 16 is a schematic overview of an embodiment of the invention,

FIG. 17 illustrate source databases in a practical example of how the invention may be applied,

FIG. 18 illustrates possible global schema classes in the example of FIG. 17,

FIG. 19 illustrates the integrated schema in the example of FIG. 17,

FIG. 20 illustrates a possible star schema in the example of FIG. 17,

FIG. 21 illustrates the metadata tables for the star schema of FIG. 20,

FIG. 22 illustrates possible objects of the Product and Sales class in OODB form in the example of FIG. 17,

FIG. 23 illustrates the linkage of Product and Sales tables in RDB form in the Example of FIG. 17,

FIG. 24 shows an example of the use of the drill-down operator in the example of FIG. 17,

FIG. 25 shows an example of the use of the roll-up operator in the example of FIG. 17,

FIG. 26 shows an example of the use of the slice operator in the example of FIG. 17,

FIG. 27 shows an example of the use of the dice operator in the example of FIG. 17, and

FIG. 28 shows an example of views obtainable in object-oriented online analytical processing.

### DETAILED DESCRIPTION OF PREFERRED EMBODIMENTS

In the following description of preferred embodiments of the invention a theoretical overview of the invention will first be given followed by a practical example of how an embodiment of the invention may be applied to a real-life situation.

The construction of a data warehouse based on heterogeneous legacy databases in accordance with an embodiment of the invention involves the following general steps:

1. Each source database will have its own schema. These local database schema must be integrated to form a common schema for the global database that comprises the collection of local databases.

2. The integration of the local database schema is captured by a frame metadata model that describes the data stored in the source databases. Importantly, as will be described further below, the frame metadata model is able to describe not only factual data but also data concerning the relationships between data and is thus able to encompass both data from relational databases and data from object oriented databases.

3. Means are provided for permitting materialization of data for user analysis in either relational or object-oriented form depending on a user request.

4. Following data materialization online analytical processing is available to a user for analysis of the materialized data.

Each of these four major steps will now be described in turn in greater detail.

Schema Integration

Schema integration enables a global view to be obtained of multiple legacy databases each of which may be formed with their own schema. A bottom up approach is taken in which existing databases are integrated into a global database by pairs. The schema of two databases are obtained (by reverse engineering if necessary) and any semantic conflicts between the databases are resolved by defined semantic rules and user supervision. Any conflicts and constraints arising from the integration of two database schemas are captured and enforced in the frame metadata model to be described further below. The basic algorithm for integrating a pair of legacy databases is:

Begin For each existing database do
Begin If its conceptual schema does not exist

then recover its conceptual schema by capturing
semantics from source database/*refer to appendix A*/

For each pair of existing database schema A and schema B do¹²
begin
Resolve semantic conflicts between schema A and
schema B; /*Procedure 1*/
Merge classes/entities and relationship
between schema A and schema B; /*Procedure 2*/
Capture/resolve semantic constraints arising
from integration into Frame Metadata Model;
end

end

end

A data exhaustive search algorithm, such as that described in “Schema Integration for Object-Relational Databases with Data Verification” Fong et al, Proceedings of the 2000 International Computer Symposium Workshop on Software Engineering and Database Systems, Taiwan, pp 185-192 maybe used to verify the correctness of the integrated schema.

Schema integration involves the identification and resolution of semantic integrity conflicts between source schemas, and then subsequently the merger of classes/entities from the source databases into the merged database with the integrated schema. Insofar as merging the schemas is concerned, the input will be two source schemas A and B and the output will be an integrated schema Y. Semantic conflicts between the source schemas A and B may include definition related conflicts such as inconsistency of keys in relational databases or synonyms and homonyms and these will require user supervision for resolution. For conflicts arising from structural differences the goal is to capture as much information as possible from the source schemas. A simple way is to capture the superset from the schemas Conflicts between data types can be transformed into a relationship in the integrated schema.

Schema integration further requires classes/entities and relationship relation data from the source databases A and B to be merged after the semantic conflicts have been resolved.

Classes and/or entities are merged using the union operator if their domains are the same. Otherwise abstractions are used under user supervision. By examining the same keys with same entity name in different database schemas, entities may be merged by union. An example of this will now be described in more detail:

Relationships and associations can be merged by capturing cardinality as illustrated in FIG. l using the following steps:

IF (class(A1) = class(B1))\hat{ }class(A2) =
class(B2))\hat{ }(cardinality(A1, A2) = 1:1)\hat{ }

(cardinality(B1, B2) = 1:n)

THEN begin Class X1 Class A1

Class X2 Class A2
Cardinality(X1, X2) 1:n;

end

ELSE IF(class(A1) = class(B1))\hat{ }(class(A2) =
class(B2))\hat{ }(cardinality(A1, A2) = 1:1 or 1:n)\hat{ }

(cardinality(B1, B2) = m:n)

THEN begin Class X1 Class A1

Class X2 Class A2
Cardinality(X1, X2) m:n;
End

Classes/entities may be merged by subtype relationship as illustrated in FIG. 2 using the following steps:

IF domain(A) ⊂ dmain(B)
THEN begin Class(X1) Class(A)

Class(X2) Class(B)
Class(X1) isa Class(X2)

End;

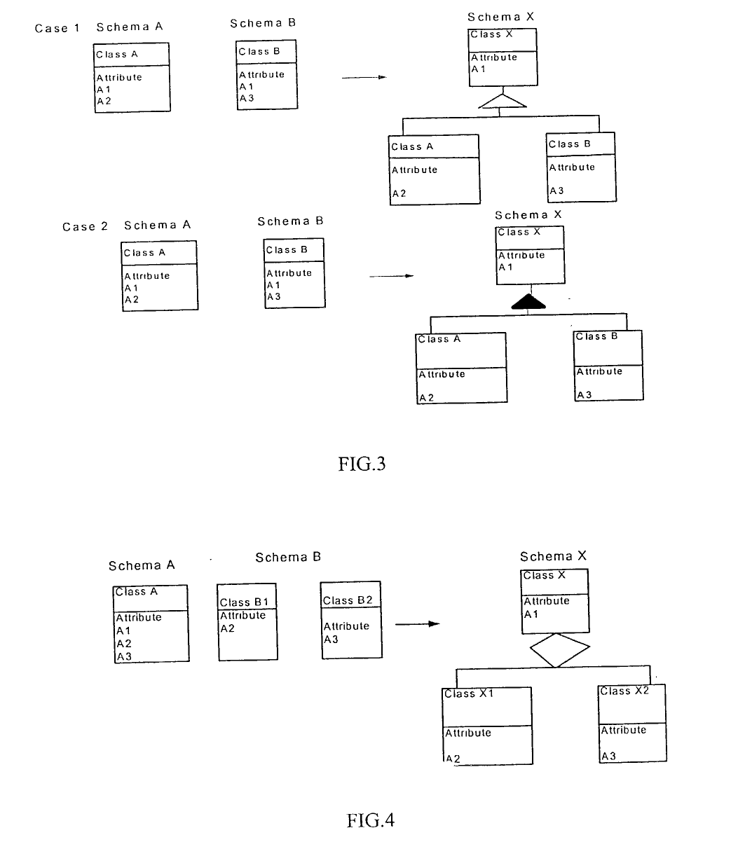

Classes/entities may also be merged by generalization as shown in FIG. 3 by the following steps:

IF ((domain(A) domain(B)) 0)\hat{ }((I(A) I(B)=0)
THEN begin Class(X1) Class(A)

Class(X2) Class(B)
Domain(X) domain(A) domain(B)
(I(X1) I(X2)) = 0

end

cELSE IF((domain(A) domain(B)) 0)\hat{ }((I(A) I(B)) 0)
THEN begin Class(X1) Class(A)

Class(X2) Class(B)
domain(X) domain(A) domain(B)
(I(X1) I(X2)) = 0
end;

Classes/entities may also be merged by aggregation as shown in FIG. 4. Aggregation is an abstraction in which a relationship among objects is represented by a higher level aggregate object. In a relational view, aggregation consists of an aggregate entity which is a relationship set with corresponding entities into a single entity set. In an object-oriented view, aggregation provides a mechanism for modeling the relationship IS_PART_OF between objects. An object stores the reference of another object that makes it a composite object. An object becomes dependent upon another if the dependent object is referred by another ‘parent’ object. When an object is deleted, all dependent objects are also deleted.

If Domain(Attr(B1))⊂Domain(Attr(A)) AND
Domain (Attr(B2))⊂Domain(Attr(A))
THEN begin aggregation(X) Class(A)

Class X1 Class B1
Class X2 Class B2
Class X owns Class X1
Class X owns Class X2

Owns means the existence of class X includes its component classes X1and X2 such that when creating Class X object, Class X1object and Class X2 object must exist beforehand or be created at the same time.

Following the integration of schema described above, an example will now be given of how the data semantics of both relational and object oriented databases may be captured into a frame metadata model will now be described in more detail.

Data operations can be used to examine data occurrence of a source database which can be interpreted as data semantics.

Step 1.1 Capture the isa relationship of a legacy database into the Frame model metadata

An isa relationship is a superclass and subclass relationship such that the domain of subclass is a subset of its superclass. The following algorithm can be used to examine the data occurrence of an isa relationship:

Relational View

Given two relations and their primary keys Rₓ, PK(Rₓ), R_{y}, PK(R_{y}) in a relational schema S, we can locate their ISA relationships as:

Begin

Select Count(PK(Rₓ)), PK(Rₓ) from Rₓ;
Select Count(PK(R_{y})), PK(R_{y}) from R_{y};
Select Count(*)=Allcount from PK(R_{y}) where PK(R_{y}) is in PK(Rₓ);
IF Count(PK(R_{y})) ≧ Allcount
THEN begin

ISA-relationship (R_{y}, Rₓ) := True;
R_{y} := subclass relation;
Rₓ := superclass relation;

End;

End;

FIG. 5 illustrates the recovered isa in UML (universal modeling language)

A similar isa relationship is defined in OODB schema as inheritance, and does not need to be examined in detail here.

The following metadata can be used to store the captured isa relationship:

Header Class

| Class_Name | Primary_key | Parents | Operation | Class_type |
|---|---|---|---|---|
| Rₓ | PK(Rₓ) | 0 | | Static |
| R_{y} | PK(R_{y}) | Rₓ | | Static |

Step 1.2 Capture generalization of a legacy database schema into frame model metadata

A generalization can be represented by more than one subclasses having a common superclass. The following algorithm can be used to examine data occurrence of disjoint generalizations such that subclass instances are mutually exclusively stored in each subclass.

| Relational View | Object-Oriented View |
|---|---|
| Given a superclass relation and its primary | Given a superclass and its OID: C, |
| key: R, PK(R), referring to its subclass | OID(R), referring to its subclass and their |
| relations and their primary key: Rⱼ₁, | OID: Cⱼ₁, OID(Rⱼ₁), ...Cⱼₙ, OID(Rⱼₙ), their |
| PK(Rⱼ₁), ...Rⱼₙ, PK(Rⱼₙ), their | generalization can be located as: |
| generalization can be located as: | |
| If ISA-relationship (Rⱼ₁, R) = True and ... | If ISA-relationship (Cⱼ₁, C) = True and ... |
| and ISA-relationship (Rⱼₙ, R) = True | and ISA-relationship (Cⱼₙ, C) = True |
| Then Generalization (R, Rⱼ₁, ...Rⱼₙ) := | Then Generalization (C, Cⱼ₁, ...Cⱼₙ) := |
| Disjoint; | Disjoint; |
| For h: = 1 to n do Select PK(Rⱼₕ) from Rⱼₕ; | For h := 1 to n do Select OID(Cⱼₕ) from Cⱼₕ; |
| For k := 1 to n do | For k := 1 to n do |
| for m := 1 to n do | for m := 1 to n do |
| if k < m | if k < m |
| then begin | then begin |
| Select Count(*)=Allcount from | Select Count(*)=Allcount from |
| PK(Rₘ) where | OID(Cₘ) where |
| PK(Rₘ) is in PK(Rₖ); | OID(Cₘ) is in OID(Cₖ); |
| If Allcount > 0 then | If Allcount > 0 then |
| Begin | Begin |
| Generalization (R, Rⱼ₁, ..., Rⱼₙ) := | Generalization (C, Cⱼ₁, ..., Cⱼₙ) := |
| Overlap; | Overlap; |
| Exit; | Exit; |
| End; | End; |
| End; | end; |

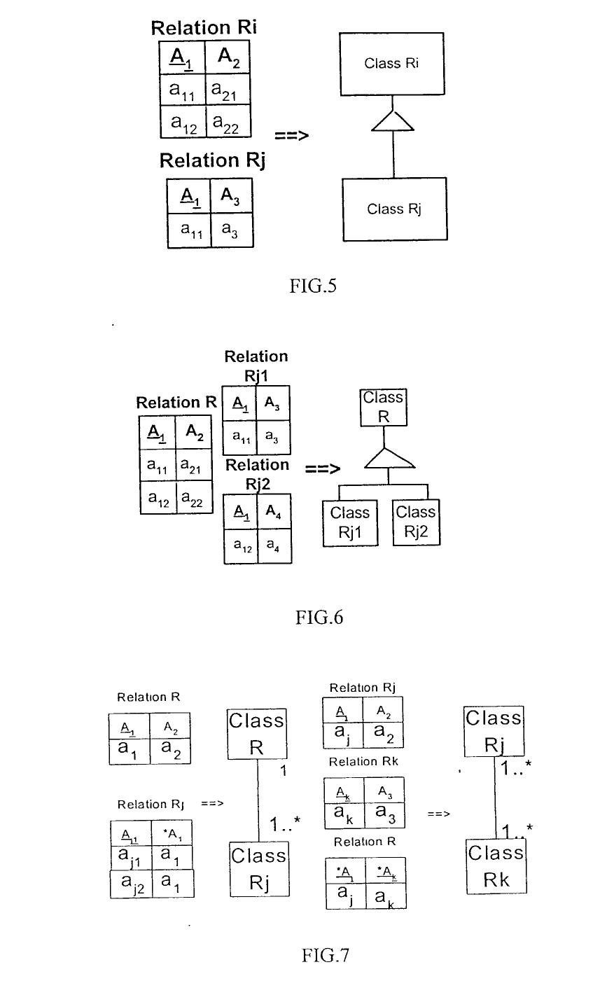

FIG. 6 illustrates in UML the recovered generalization.

The following metadata can be used to store the captured disjoint generalization:

Header Class

| Class_Name | Primary_key | Parents | Operation | Class_Type |
|---|---|---|---|---|
| R | PK(R) | 0 | | Static |
| R₁_{¹} | PK(R₁_{¹⁾} | R | Call Create_R₁_{¹} | Active |
| R₁_{²} | PK(R₁_{²⁾} | R | Call Create_R₁_{²} | Active |

Method class

| Method_{—} | Class_{—} | Para- | Seq_{—} | Method_{—} | | | Next_{—} |
|---|---|---|---|---|---|---|---|
| Name | name | meter | no | Type | Condition | Action | Seq_no |
| Create_Rⱼ₁ | Rᵢ₁ | @ | | Boolean | If(Select * from Rᵢ₂ | Create_Rᵢ₁ | |
| | | PK(Rⱼ₁) | | | where PK(Rⱼ₁) = @ | = true | |
| | | | | | PK(Rⱼ₁)) = null | | |
| Create_Rⱼ₂ | Rⱼ₂ | @ | | Boolean | If(Select * from Rⱼ₁ | Create_Rⱼ₂ | |
| | | PK(Rⱼ₂) | | | where PK(Rⱼ₂) = @ | = true | |
| | | | | | PK(Rⱼ₂)) = null | | |

Step 1.3 Capture cardinality of schema in a legacy database into the frame model metadata The cardinality specifies data volume relationship in the database. The following algorithm can be used to examine data occurrence of cardinality of 1:1,1:n and n:m.

| Relational View | Object Oriented View |
|---|---|
| Given relations and their primary keys R₁, | Given two classes and their reference |
| PK(R₁), ...Rₛ, PK(Rₛ) in a relational | attributes C₁, REF(C₁), ..., Cₙ, REF(Cₙ) in |
| schema S, we can locate its cardinality as: | an OO schema S, we can locate the |
| Select PK(R) from R; | cardinality between Ci and Cj as |
| Let i = 1; | cardinality (Ci and Cj) as follows: |
| While not at end of instance(Pki(R)) do | For i = 1 to n do |
| Begin Select Count(FK(Rj)) = Ci from Rj | Select REF(C₁), C₁ from S; |
| where | If REF(C₁) permit NULL value |
| FK(Rj)= Instance(Pki(R)); | Minimun = True; |
| Let i = i + 1; | Else If REF(C₁) is singular |
| End; | THEN max(i) = 1; |
| Let minimum(Rj) = minimum(C1,...Cn); | Else If REF(C₁) is a set reference |
| Let maximum(Rj) = maximum(C1,...Cn); | THEN max(i) = n; |
| If Minimum(Rj) = 0 | End; |
| Then cardinality (R, Rj) = 1: (0, n) | If Minimum then |
| Else If maximum (Rj) = 1 | Card(i) = (0, max(i)); |
| Then cardinality (R, Rj) = 1: 1 | Else |
| Else cardinaliy (R, Rj) = 1:n; | Card(i) = max(i); |
| If cardinality (R, Rj) = n:1 and cardinality | End; |
| (R, Rh) = n: 1 | Let Cardinality (C₁, Cⱼ) = card(i) : card (j) |
| Then cardinaltiy (Rj, Rh) = m:n | |

FIG. 7 illustrates in UML the recovered conceptual schema. The following metadata can be used to store the captured 1:n cardinality between R and Rⱼ,:

Attribute Class

| Class_{—} | Attribute_{—} | Method_{—} | Attribute_{—} | Default_{—} | Car- | |
|---|---|---|---|---|---|---|
| name | Name | name | type | value | dinality | Description |
| R | | | R₁ | | n | Associated class attribute |
| Rᵢ | | | R | | 1 | Associated class attribute |

Step 1.4 Capture aggregation of a legacy database schema into the frame model metadata. Aggregation is an abstraction concept for building composite objects from their component objects. The following algorithm can be used to examine data occurrence of aggregation such that an aggregation object must consist of all of its component objects:

| Relational View | Object Oriented View |
|---|---|
| Given an aggregation relation with its primary | Given an aggregation class with its |
| keys, AR, PK(AR) referring to | reference attribute pointers AC, |
| its component relations with its foreign | REF₁(AC),....REFn(AC) referring to its |
| keys, CR₁,...CRn,FK(CR1),...,FK(CRn) | component classes with its OID, |
| from relational schema S, the aggregation | CC1,....CCn, OID (CC1),....OID(CCn) |
| can be located as: | from schema S, the aggregation can be |
| Let i=1; | located as: |
| If PK(AR)=FK(Cri) | For i=1 to n do |
| Then begin Select FK(CRi) from S; | Begin for j=1 to n do |
| While not at end of | Begin |
| instance(FK(CRi)) do | If REFi(AC)=OID(CCj) |
| Select count(FK(CRi))= Ci | Then begin |
| from CRi | Select REFi(AC) from AC; |
| where instance(FK(CRi)) = | While not at end of |
| Null; | instance(REFi(AC)) do |
| Let i=i+1; | Select Count(REFi(AC))=Cj from |
| End; | AC |
| For i=1 to n do | where |
| Begin If Ci > 0 | instance(REFi(AC))=Null; |
| Then Aggregation (AR, CRi)=false | break; |
| Else Aggregation (AR, CRi)=true; | end; |
| End; | for j=1 to n do |
| | begin if Cj>0 |
| | then aggregation (AR, CCj) = false |
| | else aggregation (AR, CCj) = true; |
| | end; |

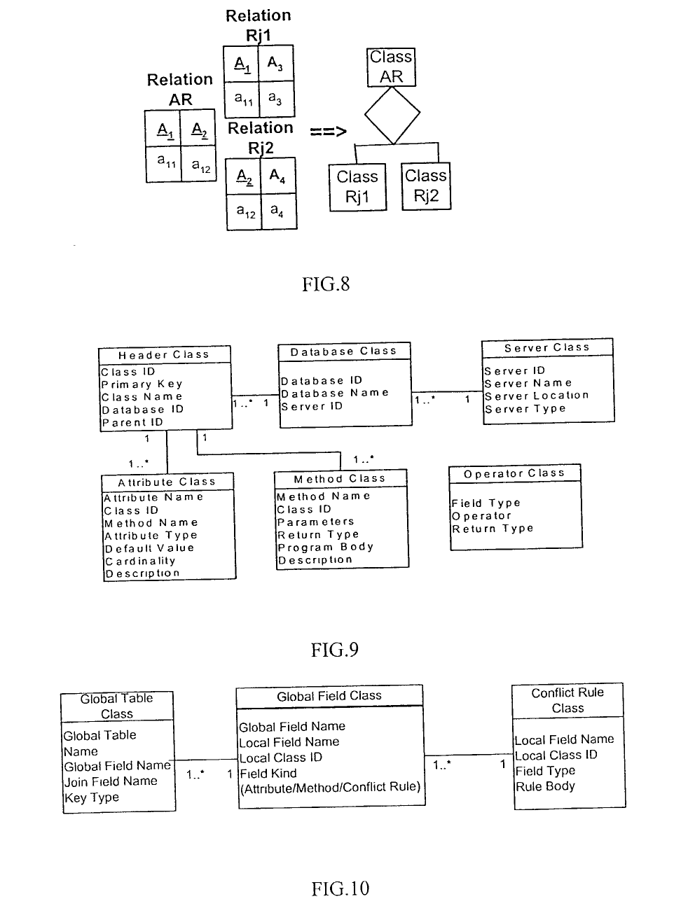

FIG. 8 illustrates in UML the recovered aggregation.

The following metadata can be used to store the captured aggregation:

Header Class

| Class_Name | Primary_key | Parents | Operation | Class_Type |
|---|---|---|---|---|
| CR₁ | PK(CR₁) | 0 | | static |
| CR₂ | PK(CR₂) | 0 | | static |
| AR | PK(CR₁), PK(CR₂) | 0 | Call Create_AR | active |

Method class

| Method_{—} | Class_{—} | | Seq_{—} | Method_{—} | | | Next_{—} |
|---|---|---|---|---|---|---|---|
| Name | name | Parameter | no | type | Condition | Action | Seq_no |
| Create_{—} | AR | @PK(CR₁) | | | If ((Select * from CR₁ | Insert | |
| AR | | @PK(CR₂) | | | where PK(CR₁) = @ | AR | |
| | | | | | PK(CR₁)) ≠ null) and If | (@PK(CR₁), | |
| | | | | | ((Select * from | | |
| | | | | | CR₂ where | | |
| | | | | | PK(CR₂) = @PK(CR₂) ≠ | @PK(CR₂)) | |
| | | | | | null) | | |

Frame metadata model

A frame metadata model is used to integrate the source relational and object-oriented schemas and to capture the global schema that is derived from the source schema integration described above. The frame metadata model is also capable of storing the derived semantics of the integrated schema and any constraints derived during schema integration.

To facilitate metadata modeling, a frame metadata model is used which consists of the active and dynamic data structure of RDB and OODB. The frame metadata model in class format stores the method of operations of each class in four tables as shown in Table 1.

TABLE 1

| | |
|---|---|
| Header Class{Class_Name | /* a unique name in all system */ |
| Primary_Key | /* an attribute name of unique value */ |
| Parents | /* a list of class names */ |
| Operation | /* program call for operations */ |
| Class_Type | /* type of class, e.g. active and static */} |
| Attribute Class{Attribute_Name | /* a unique name in this class */ |
| Class_Name | /* reference to header class */ |
| Method_Name | /* a unique name in this class for data operation */ |
| Attribute_Type | /* the data type for the attribute */ |
| Associated_attribute | /* association between classes */ |
| Default_Value | /* predefined value for the attribute */ |
| Cardinality | /* single or multi-valued */ |
| Description | /* description of the attribute */} |
| Method class{Method_Name | /* a unique name in this class */ |
| Class_Name | /* reference to header class */ |
| Parameters | /* a list of arguments for the method */ |
| Method_Type | /* the output data type */ |
| Condition | /* the rule conditions */ |
| Action | /* the rule actions */} |
| Constraint class{Constraint_Name | /* a unique name for each constraint */ |
| Class_Name | /* reference to header class */ |
| Method_Name | /* constraint method name */ |
| Parameters | /* a list of arguments for the method */ |
| Ownership | /* the class name of the method owner */ |
| Event | /* triggered event */ |
| Sequence | /* method action time */ |
| Timing | /* the method action timer */ } |

The frame metadata model is used to integrate the source relational and object-oriented databases. Importantly both relational and object-oriented databases can be integrated in the same frame metadata model. Not only does this enable a data warehouse to be constructed from heterogeneous source databases that include both relational and object-oriented databases, but it also (as will be described further below) enables the data warehouse to be queried either from a relational view or from an object-oriented view.

Star Schema Formation and Data Materialization

One of the advantages of the frame metadata model approach is that it provides a local database metadata system that provides information on each of the local databases that have been integrated into a global database. FIG. 9 shows the UML of the local database metadata schema. However, the frame metadata model also includes global information necessary for enabling global inquiries to be made of the data warehouse. FIG. 10 therefore shows the UML of the integrated database metadata schema with particular reference to the global classes including: global table class, global field class and conflict rule class. The global table class describes the global table view information, the global field class describes the field which is integrated into the global table view, and the conflict rule class describes the local fields conflict resolutions.

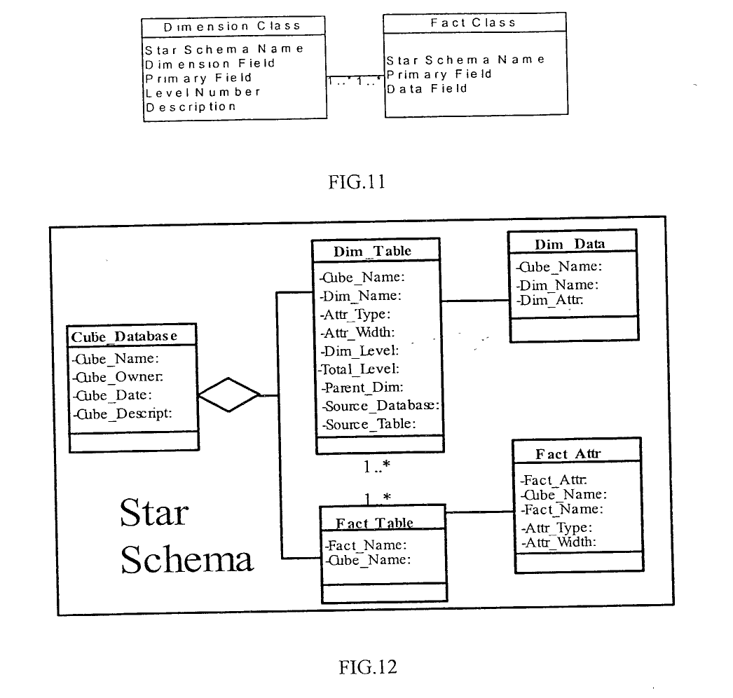

These global fields may be used to define new global views for each global database application. This is preferably achieved by using a star schema. A star schema structure takes advantage of typical decision support queries by using one central fact table for the subject area and many dimension tables containing de-normalized descriptions of the facts. In a preferred embodiment of the present invention, a star schema is created on the global schema to enable multi-dimensional queries to be performed. FIG. 11 shows the UML of a simple one dimension star schema which includes two classes, dimension class and fact class. The star schema may be implemented easily in an embodiment of this invention because the frame metadata model can accommodate multi-fact tables in many-to-many relationship between the dimension table and the fact table.

As will be described further below, the star schema is used to create data cubes for online analytical processing (OLAP) and FIG. 12 shows the UML for the technical star schema metadata in an embodiment of the invention To enable multidimensional queries multiple dimension tables and fact tables are provided.

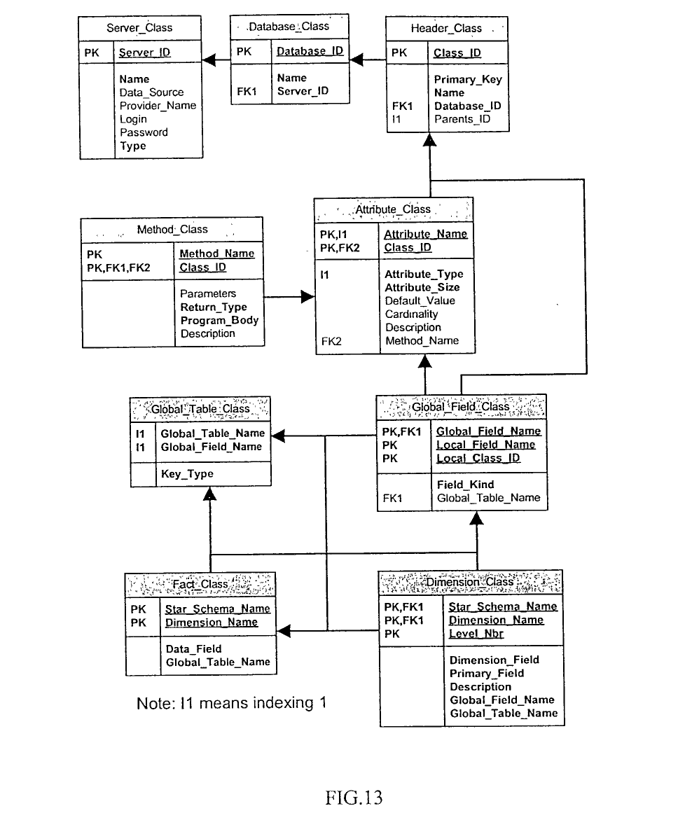

FIG. 13 illustrates for better understanding of the invention the relationship between the frame metadata model (header class, attribute class, method class), the global schema (global table class, global field class) and the star schema (fact class and dimension class). FIG. 13 also includes the database class and server class which may be considered to be further refinements of the header class as shown in FIG. 9.

Data materialization requires the development of common data cubes and common warehouse views are formed based on the star schema. An important aspect of the present invention, at least in its preferred forms, is that the data may be looked at in either a relational view or an object-oriented view.

To begin with, the following steps may be used to load data into data cube. The process will generate a relational multi-dimensional data model and its materialized view. The process flow in the methodology framework is as follows:

Specify data source—The data warehouse designer determines the task-related data table(s) from the global database schema to build up the necessary star schema.

Define a set of dimensions—The data warehouse designer decides upon the dimension level of the attributes in the data source as the dimensions of the star schema and then constructs these dimensions into a hierarchy structure for aggregation and classification. This information will be stored into Dim_Table and Dim_Data as the star schema metadata.

Define a set of measurements—The data designer chooses interested measurements of the star schema and decides the aggregation functions, such as sum, avg, count, max and so on for the measurement. This information will be stored into Fact_Attr as our star schema metadata.

Cube data generation—This step involves retrieving the physical data from local databases and moves the data to the star schema database by following the pre-defined configuration designed in the previous steps. There are two kinds of data, which will be moved into the data warehouse. One is dimension data for the star schema. The other is fact data for the star schema. The following shows the dimension data algorithm and the fact data algorithm.

/* Dimension data algorithm */
Procedure Dimesion_Data_Generation (Dim_Table)
{DECLARE dim_cursor CURSOR for

Select DISTINCT Dim_Name, Cube_Name, Dim_Attr
From Global Database Schema
Where (the Dim_Table's Dim_Name is empty)
ORDER BY Dim_Name

}// end of Dimension_Data_Generation( )
/* Fact Data Algorithm - Main program */
Procedure Create_Cube (Dim(N), Measurements(M))
{//Input: Dim(N)
// Output: Dimension Permutation:
// {S(x)|x: 0˜2^{N}−1}
Variant_Dimension_Permutation (Dim(N))
// Setting measurements value of Aggregation Function
eg., AVG, COUNT, SUM.
AF(M1,M2 . . . Mm)
// Generated SQL Procedure
Generate_SQL( )
}// end of the Create_Cube procedure
/* Subprogram */
Procedure Variant_Dimension_Permutation (Dim(N))
{//Input: Dim(N) To leave with dimension name of array
//Output: Cube( ) To leave with result of dimension changing
N Dimension number
Tr Index of array transform values
BinaryIndex Index of binary operation
For Tr 0 to 2^{N}−1
do

For BinaryIndex 0 To N−1

do

If (Tr Mod 2 = 1) Then
Cube[Tr] [BinaryIndex]Dim(BinaryIndex)
Else
Cube [Tr] [BinaryIndex] ‘ALL’
Tr = (Tr − (Tr Mod 2))/2

For x 0 to 2^{N}−1
do

S(x) = Cube [x];

}//end of Variant_Dimension_Permutation procedure

Procedure AF(M1,M2 . . . Mm)
{For x 0 to 2^{N}−1
do

S(x) S(x) + Aggregation Function (measurements)

}// end of AF procedure
Procedure Generate_SQL( )
{For 1 0 to 2^{N}−2

do

Select{S(i)}, {AF(M1,M2 . . . Mm) }
From Data_Base
Group BY S(i)
Union
Select{S(2^{N}−1)}, {AF(M1,M2 . . . Mm) }

From Data_Base
Group BY S(2^{N}−1)

}// end of Generate_SQL Procedure

Creating a data cube requires generating the power set (set of all subsets) of the aggregation columns. Since the cube is an aggregation operation, it makes sense to externalize it by overloading the aggregation. In fact, the cube is a relational operator, with GROUP BY and ROLL UP as degenerate forms of the operator. Overloading aggregation can conveniently be achieved by using the SQL GROUP BY operator. If there are N dimensions and M measurements in the data cube, there will be 2^{N}−1 super-aggregate values. If the cardinality of the N attributes are D₁, D₂, . . . , D_{N} then the cardinality of the resulting cube relation would be Π(Di+1).

The sub-procedure Variant_Dimension_Permutation utilizes all dimension permutations such as logic truth tables. For example, if there are N dimension then there will be 2^{N}permutation results. Each permutation result will be generated to a SQL command in Generate _SQL sub-procedure. AF represents the aggregation function for the measurements. The SQL command will match the aggregation function with Group By function. Finally, All SQL commands will be Union to become a set of SQL commands for the global database.

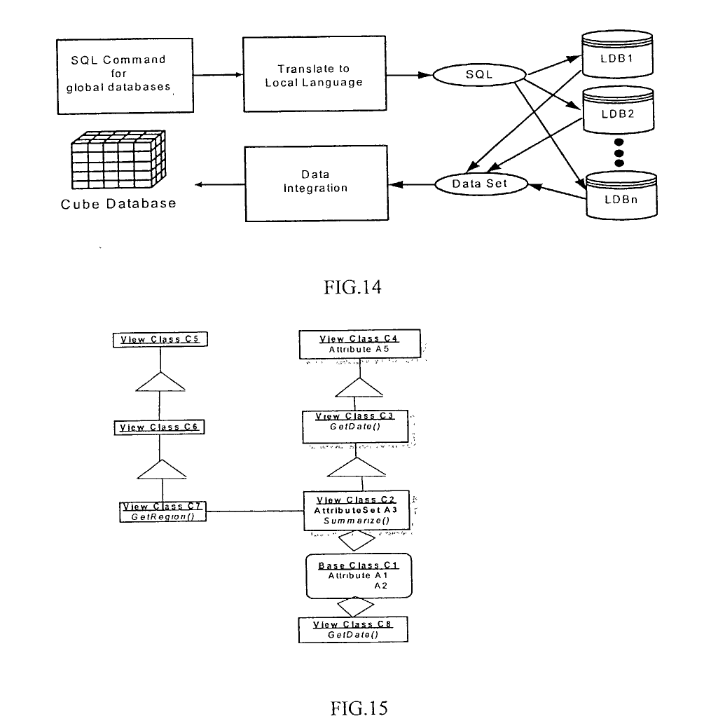

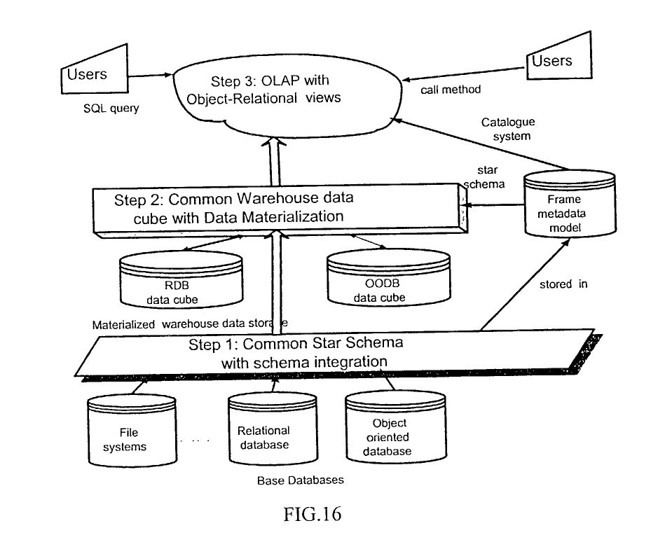

FIG. 14 illustrates the process of data integration to form a data cube. A global query command will be translated into several local database query commands. This requires an effective translation method to control the local queries. The result of these local queries will be integrated together and stored in the Dim_Data and Fact_Table.

When data materialization is to be performed for a relational view, the OID, stored_OID and each object of OODB are converted into the primary key, foreign key and each tuple of RDB as shown below: (note: The stored_OID is a pointer addressing to an OID which was generated and stored in the OODB.) Each OODB class data is unloaded into a sequential file with the following algorithm:

For each class in the OODB do
Begin

If the corresponding table has not been created
Then create a table with all the base type attributes of the classes;
If the class has subclasses
Then begin

If the corresponding table has not been created
Then create tables for the subclasses with attributes and
primary key of its superclass;
If any subclass associates with another class
Then begin

case association of
Set attribute:
begin If corresponding table for set attribute is not created
Then create a table for the class with primary
keys of owner class primary
key and attributes of the set, and
replace superclass's key by foreign key

end;
1:1 or 1:n association:

begin If the corresponding table
for associated class is not created
Then create a table for the class and
its attributes with owner primary
key as foreign key;

end;
m:n association:

begin If corresponding class for associated class is not created
Then create a table to hold primary keys of the two classes;
End;

End-case

Each sequential file is then reloaded into a RDB table.

Alternatively, if a user requests an OO view for the data warehousing, the relevant RDB is materialized into an OO view by converting RDB data into OODB objects. Each tuple of RDB is converted to each object of OODB where an OID is system generated for each object. The primary key, and the foreign key of each tuple of RDB are converted to attribute and stored_OID of each object of OODB using the algorithm as shown below:

Begin Get all relation R₁, R₂ . . . Rₙ within relational schema;
For i = 1 to n do
/* load each class with corresponding relation tuple data */
Begin while Rⱼ tuple is found do

output non-foreign key attribute value to a sequential
file F₁ with insert statement;

end;
For j = 1 to n do
/*update each loaded class with its associated attribute value */
begin while Rⱼ tuple with a non-null foreign key value is found do
begin Get the referred parent relation tuple from Rₚ
which is a parent relation to Rⱼ,

Output the referred parent relation tuple to a sequential
file Fⱼ with update statement;
Get the referred child relation tuple from Rⱼ;
Output the referred child relation tuple to the
same file Fⱼ with update statement;
end;

end;
For k = 1 to n do
/*update each subclass to inherit its superclass attribute value */
Begin while a subclass relation Rₖ tuple is found do

begin
Get referred superclass relation tuple from
Rₛ which is a superclass relation to Rₖ;
Output referred superclass relation tuple to
a sequential file Fₖ with update statement;
end;

end;

The sequential files are then reloaded into an OODB in the sequence of file Fᵢto fill in the class attributes' values, file Fⱼto fill in associated attributes' values and file Fₖto fill in subclasses' inherited values.

Following creation of the data cubes, the data may be analysed using online analytical processing (OLAP) with either relational or object oriented views.

Firstly OLAP with relational views will be described. The function of SQL for multi-dimension query is enhanced by adding the X/Y dimension column to describe the dimension condition.

SELECT
[Alias.]Select_Item
[AS Column_Name] [, [Alias.]Select_Item [AS Colunm_Name] . . . ]
FROM GlobalTableName/StarSchemaName [,
GlobalTableName[Alias] . . . ]
[XDTMENSION BY Column_name [ROLLUP/DRILLDOWN]
[LEVEL number] [, Column_name [ROLLUP/DRILLDOWN]
[LEVEL number] . . . ]]
[YDIMENSION BY Column_name [ROLLUP/DRILLDOWN]
[LEVEL number] [, Column_name [ROLLUP/DRILLDOWN]
[LEVEL number] . . . ]][WHERE condition expression]

The Select_Items are the output fields which are selected. The Global_Table_Names are the source table of global schema that the users select. The StarSchemaName is the target star schema that the users select. The Column_Name of XDIMENSION is the dimension on the multi-dimension query of XDIMENSION. The [ROLL UP/DRILL DOWN] option is the scroll condition. If the ‘ROLL UP’condition is selected, the scroll condition is up. If the ‘DRILL DOWN’option is selected, the scroll condition is down. The level number determines the scroll level. The YDIEMENSION is same as XDIMENSION. The condition expression is the boolean expression, such as ‘fielda=fieldb’.

If OLAP with object-oriented views is selected, the OO model has a semantically richer framework for supporting multi-dimensional views. With the isa and class composition hierarchies, view design is much facilitated in the OO model, as the dimension aggregations can be considered at each level. The support of complex objects in OO provides less redundant data as compared with the fact tables in the relational model. Query time is faster because the OO model offers methods to summarize along its predicate as compared to the join cost between multiple tables in the relational model. The use of virtual classes and methods implies that the OO model can store some computable data as a function rather than as fixed values. Using these OO features, the users can utilize the object model to define warehouse queries more intuitively, as to be shown in the example described further below.

FIG. 15 shows an object model. In this figure, the objects are shown in boxes with class names, data members and methods. The triangles indicate an is-a hierarchy, and the diamonds indicate a class composition hierarchy between connected (sets of) objects. They can be considered as references instead of containments.

Following the above detailed general description, an overview of an embodiment of the invention may be described with reference to FIG. 16, which illustrates schematically the basic steps involved. Firstly the schema of the source databases are integrated into a global schema. The source databases may be either relational or object oriented databases but both types of source database may be integrated by means of a frame metadata model that describes not only the source data, but also relationships between data in object-oriented databases, and further describes the constraints derived from the integration of the source database schema into the global schema.

The frame metadata model also includes a common star schema which may be used for interrogating and analyzing the data warehouse. Using the common star schema data may be materialized either into a relational data cube or into an object-oriented data cube depending on the needs of a user. A user may then use online analytical processing techniques (eg by means of an SQL query or by a call method) to obtain either relational or object oriented views of the data.

### EXAMPLE

For the benefit of better understanding of the invention, a detailed practical example will now be described. It should be understood, however, that this example is by way of illustration only and is not intended to be limiting in any way, and the skilled reader will understand that many variations are possible within the spirit and scope of the invention.

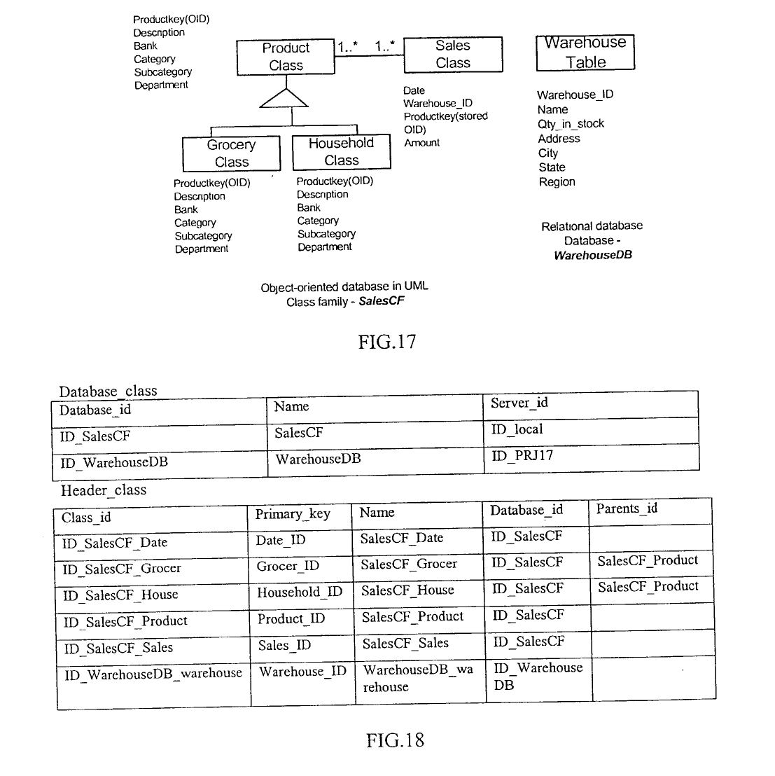

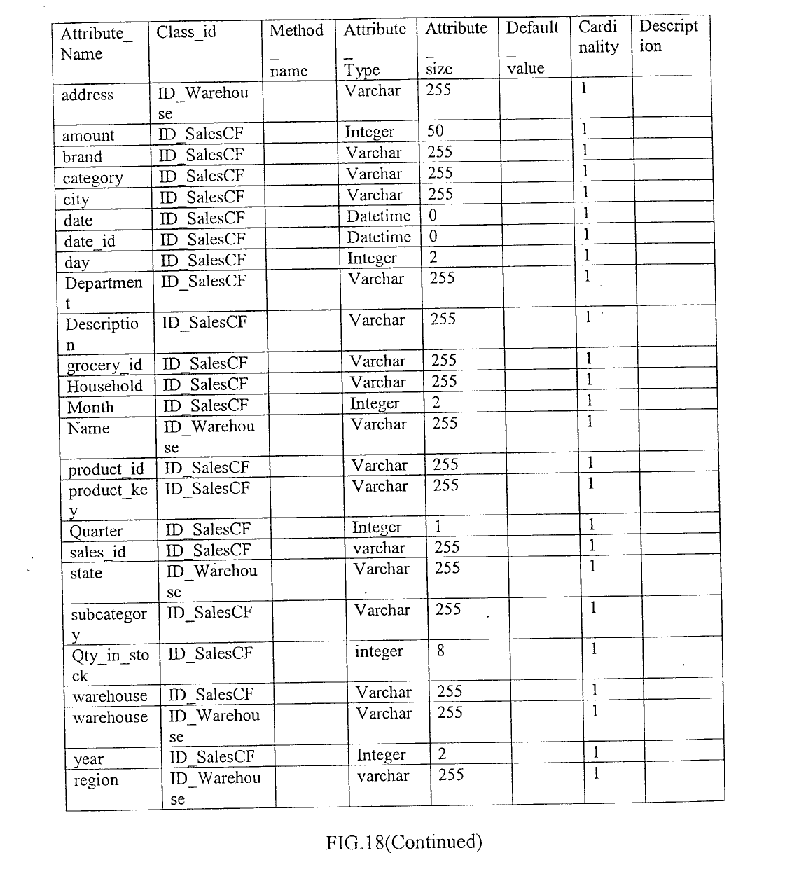

A company has two main sales sub-departments—grocery and household. The grocery department handles the sales of eatable food and drinks, while the household department handles the sales of non-eatable household supplies. These two-sub departments are under the control of the sales department. Their products data and the company's sales data are stored in an OODB. However, the purchasing department has its warehouse database in RDB form, named WarehouseDB. The sales department stores its data under the same class family, named SalesCF, where CF stands for class family. There are two main classes in SalesCF: Product class and Sales class for storing product and sales information respectively. Two sub-classes are provided under the Product class for the grocery and household sub-departments. These two subclasses inherit all the attributes of Product superclass as shown in FIG. 17.

Step 1: Star Schema Formation with Schema Integration

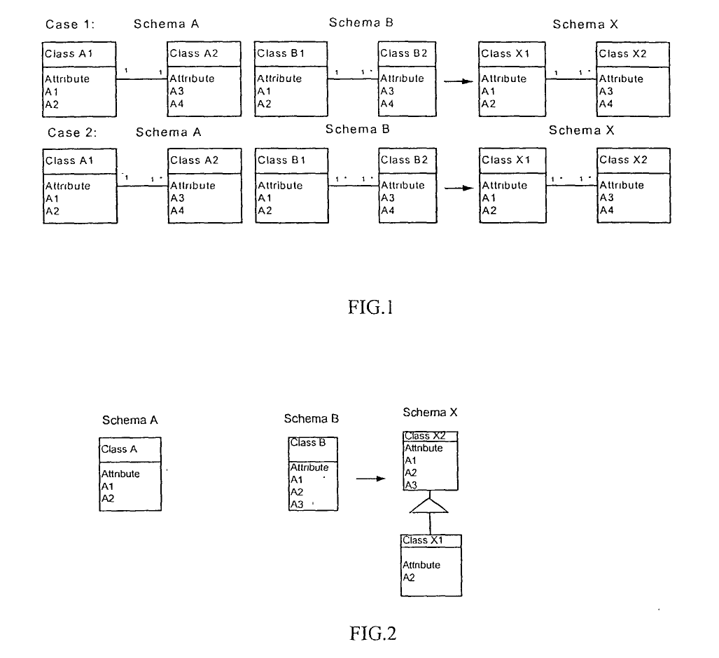

Since more than one server will be used as the data source, a Server class is added into the frame metadata model structure. One server can contain more than one database, which can have more than one header. Thus a Database class is also added into the frame metadata model structure, and the global schema classes are as shown in FIG. 1 8.

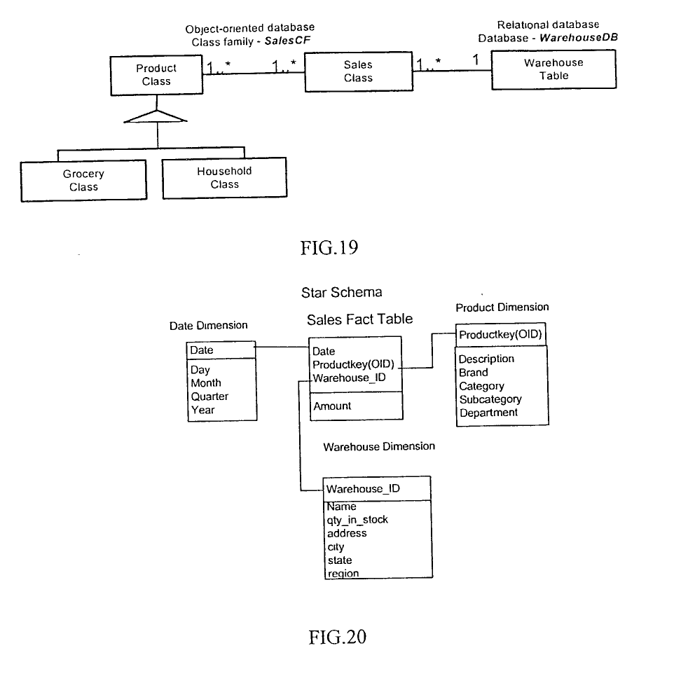

After schema integration, there is a cardinality of 1:n between Warehouse table and Sales class as shown in FIG. 19 where Warehouse_ID is used as a foreign key/stored_OID.

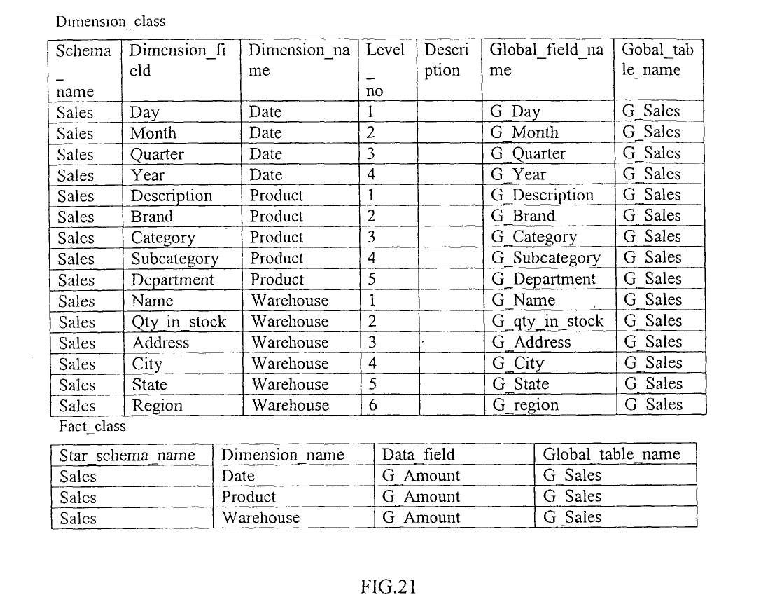

Based on user requirements to query the Sales table, a star schema is created as shown in FIG. 20. FIG. 21 shows the metadata tables for the star schema in this example.

Step 2: Data Cube Development with Data Materialization

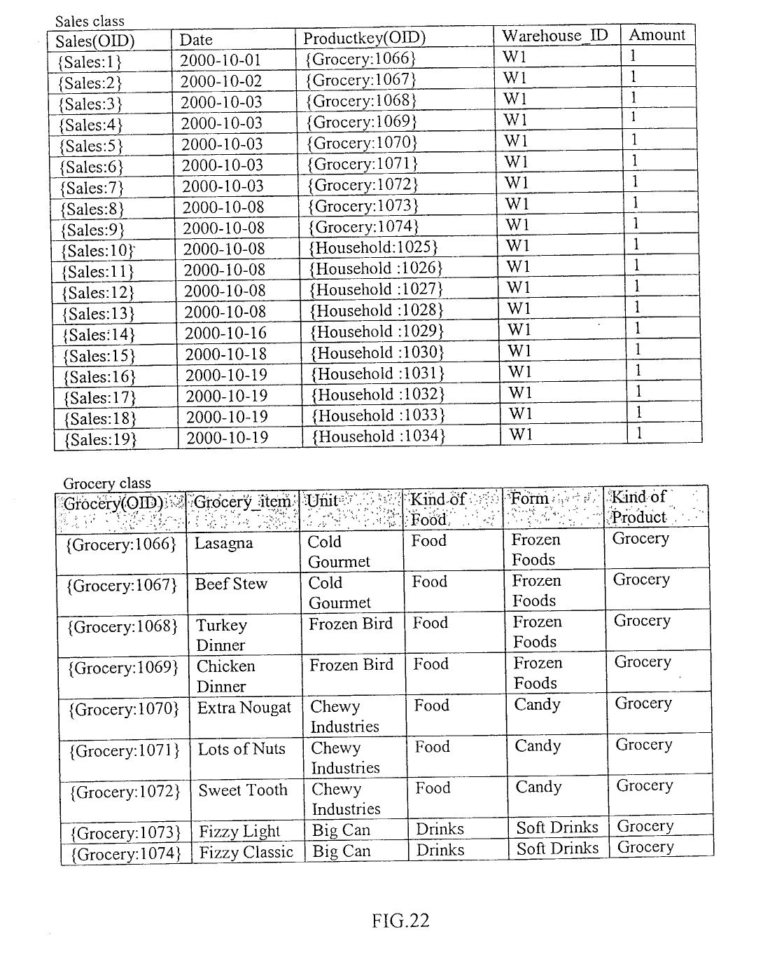

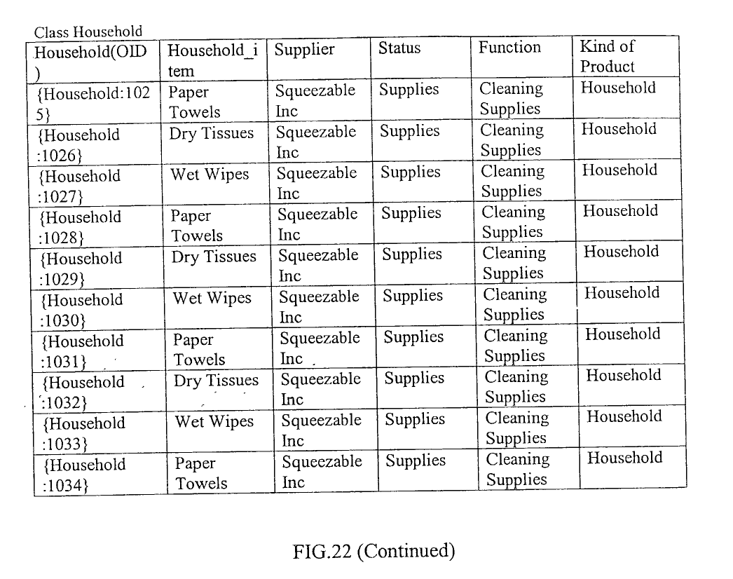

The objects of the Product class in OODB are shown in FIG. 22 where Productkey are OIDs. The objects of Sales class in OODB are also shown in FIG. 22.

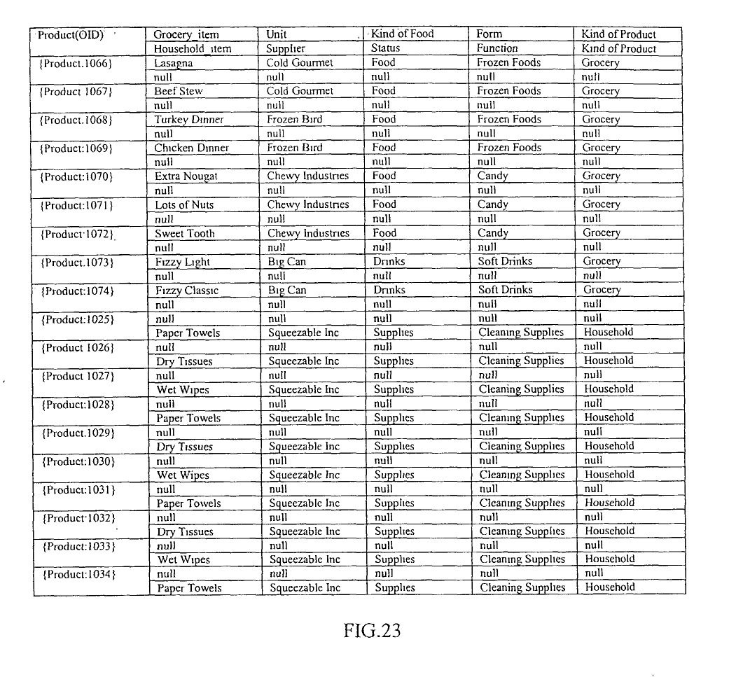

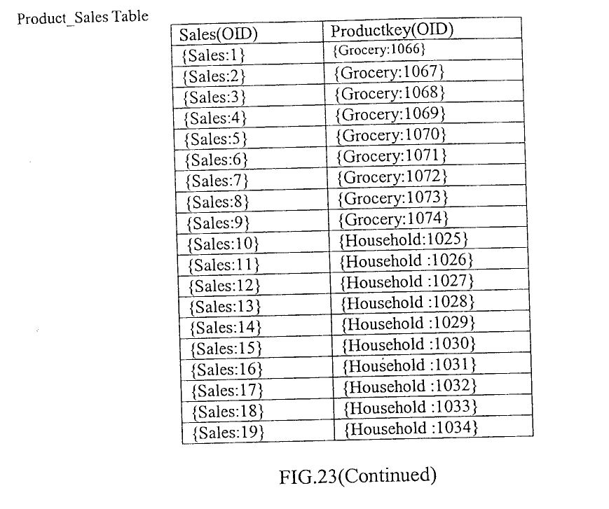

Because of the m:n association between Product class and Sales class for them to be materialized into RDB of product table and sales table, there is a m:n cardinality between the Product table and the Sales table. The product table consists of data integration of the Household table and the Grocery table. As a result, it is necessary to create a relationship relation Product_Sales table for the linkage of these two tables as shown below where stored_OID in OODB becomes the foreign key in RDB as shown in FIG. 23.

Step 3: OLAP Processing

3.1 OLAP with Relational View

To support OLAP, the data cube provides the following capabilities: roll-up (increasing the level of abstraction), drill-down (decreasing the level of abstraction or increasing detail), slice and dice (selection and projection). Table 2 describes how the data cube supports the operations. This table displays a cross table of sales by dimension region in Product table against dimension category in Warehouse table.

TABLE 2
A CrossTab view of Sales in different
regions and product categories.

| | Food Line | Outdoor Line | CATEGORY_total |
|---|---|---|---|
| Asia | 59,728 | 151,174 | 210,902 |
| Europe | 97,580.5 | 213,304 | 310,884.5 |
| North America | 144,421.5 | 326,273 | 470,694.5 |
| REGION_total | 301,730 | 690,751 | 992,481 |

(i) Drill-Down

The drill-down operator is a binary operator, which considers the aggregate cube joined with the cube that has more detailed information and increases the detail of the measure going to the lower level of the dimension hierarchy. For example, when a user drills down into dimension Asia region, the following SQL query shows the query language syntax for drill-down operator:

SELECT County, Food Line, Outdoor Line
FROM Sales_Cube
X_DIMENSION Drill-Down from Region to Country
Where Region=‘Asia’

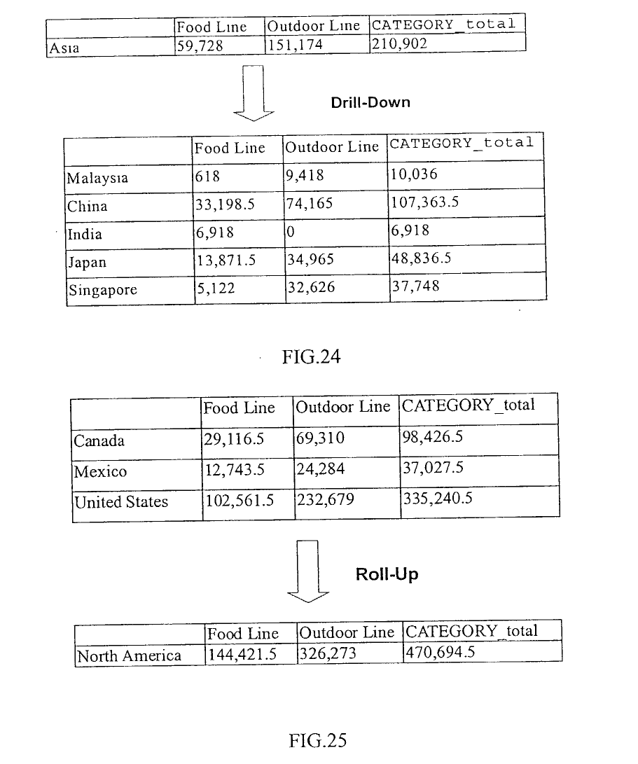

FIG. 24 shows the results for the drill-down operator.

(ii) Roll-Up

The roll-up operator decreases the detail of the measure, aggregating it along the dimension hierarchy. For example, when we roll up from countryside in North-America region, the following query shows the query language syntax for roll-up operator:

SELECT Region, Food Line, Outdoor Line
FROM Sales_Cube
X_DIMENSION Roll-Up from Country to Region
Where Region=‘North America’

FIG. 25 shows the results for the roll-up operator.

iii) Slice

The slice operator deletes one dimension of the cube, so that the sub-cube derived from all the remaining dimensions is the slice result that is specified. For example, when we slice into the value North America of dimension region, the following SQL query shows the query language syntax for slice operator:

SELECT Region, Food Line, Outdoor Line
FROM Sales_Cube
X_DIMENSION := Slice Region
Where Region=‘North America’

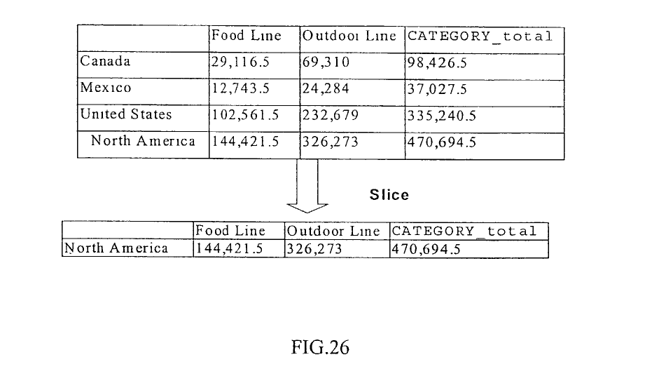

FIG. 26 shows the results of the slice operator.

(iv) Dice

The dice operator restricts the dimension value domain of the cube removing from this domain those values of the dimension that are specified in the condition (predicate) expressed in the operation. For example, when a user dices into North America of dimension region and Outdoor Line of dimension category, the following SQL query shows the query language syntax for dice operator:

SELECT County, Food Line, Outdoor Line
FROM Sales_Cube
X_DIMENSION:=Dice Region and Category
Where Region=‘North America’ and Category=‘Outdoor Line’

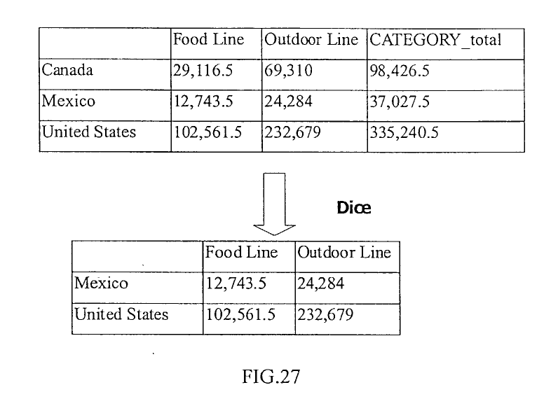

FIG. 27 shows the results of the dice operator.

3.2 OLAP with OO Views

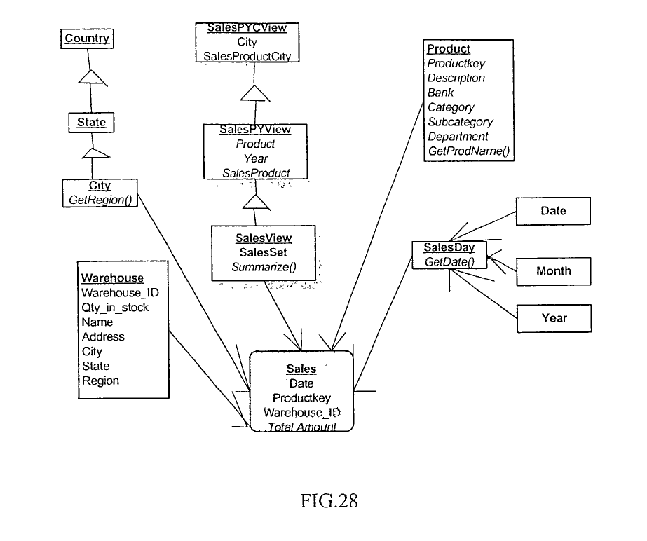

An object-oriented model provides better flexibility and maintainability than a relational model. With the help of the frame metadata model, complex relationships such as encapsulation can be implemented by using method class, and inheritance by attribute class. Data warehousing OLAP is manifested through views. FIG. 28 shows an example of views, in which Sales by Year View is the view with sales and year data for the users, if users want to include City dimension, they can use Sales by Year View to inherit a new Product by Year by City View. Also rollup and drill-down operation can be implemented through inheritance. Each contained/referred object has its accessing methods which are made available to the complex object Sales. A ViewManager class could handle views (e.g. SalesView) derived from the Sales (fact) class. An SalesView can contain a set of Sales as SalesSet and a Summarize( ) method which acts on the SalesSet to obtain TotalSales. Queries can be handled by subclassing SalesView by the pivoting dimensions. To solve the summarized query of Total Sales by Product by Year, an SalesPYView could be defined with parameters Product & Date by the ViewManager as follows:

For (each Sales in Sales.extent) do
Get the SalesPYView
which has Product & Year as that in the Sales object.
If there isn't any such SalesPYView
Then create a new SalesPYView and initialise it with Product & Year.
Add Sales to the SalesList of the SalesPYView
The result of the query can be obtained by performing:
For (each SalesPYView) do
invoke summarize to get TotalSales.

A rollup may be performed on City by creating a new class, SalesPYCView inheriting from the SalesPYView class with an additional City member. Note that a drill-down means merely traversing one level up the hierarchy. The Common Warehouse Schema (CWS) in both models contains Base classes which include some directly mappable classes and some derived (View) classes based on summarizing queries. Furthermore, views (Virtual classes) can be inherited from these Base classes. These views may be partially or completely materialized. For example, in FIG. 28, SalesSet in superclass SalesView can be computing by the aggregate of SalesProduct in its subclass SalesPYView. Similarly, SalesProduct in class SalesPYView can be computed by the aggregate of SalesProductCity in its subclass SalesPYCView. The result is a faster computation of total amount (based on the aggregate of subclass) in a superclass.

Method calls supported in the frame model can be used to store more sophisticated predicates to trigger business rules. For example, if a user wants to display the list of out of stock products, the following frame metadata definitions may be established:

Warehouse_Header_Class

| Class_Name | Parents | Operation | Class_Type |
|---|---|---|---|
| Warehouse | 0 | Call check_stock | active |

sWarehouse_method_class

| Method_{—} | Class_{—} | | Method_{—} | | |
|---|---|---|---|---|---|
| name | name | Parameter | type | Condition | Action |
| Check_{—} | Ware- | @Product | Integer | If (Select * from Warehouse, | Select * from |
| stock | house | key, | | Product where Total_amount | Warehouse, Product |
| | | @Ware- | | >Qty_in_stock) ≠ null | where Total_amount > |
| | | house_ID | | | Qty_in_stock |
| | | | | | SalesSet=@Salesset |

The method call in Frame metadata model for this specific case is as follows:

Call method Check_stock (@Productkey, @Warehouse_ID) on class Warehouse

In summary, the present invention, at least in its preferred forms, provides a method for establishing a data warehouse based on heterogeneous source databases which may include both relational databases and object-oriented databases. A frame metadata model is used both to capture any constraints arising from the local schema integration, and also to capture any relationships between objects in object-oriented source databases. Following establishment of the data warehouse data may be abstracted and analysed in either relational or object-oriented views.

It will be understood that the examples described above are by way of illustration and are not intended to be limiting in scope. Variations within the, spirit and scope of the invention will be readily apparent to a skilled reader.

1. A method for establishing a data warehouse from a plurality of source databases including at least one relational database and at least one object-oriented database, comprising the steps of:
a. integrating the schema of said plurality of source databases into a global schema, including resolving semantic conflicts between said source databases, and
b. establishing a frame metadata model for describing data stored in said local databases, said frame metadata model including means for describing any constraints developed during schema integration and further including means for describing relationships between data stored in local object-oriented databases.

2. A method as claimed in claim 1 wherein data is abstracted from said local databases into a star schema to create a data cube for data analysis.

3. A method as claimed in claim 2 wherein said data cube may be either a relational or an object-oriented data cube.

4. A method as claimed in claim 2 wherein said data cube may be queried by online analytical processing techniques.

5. A method as claimed in claim 1 wherein said step of local schema integration is carried out by integrating database schemas in pairs.

6. A method as claimed in claim 5 wherein said step of local schema integration includes (a) resolving semantic conflicts between a said pair of database schemas, and (b) merging classes and relationships.

7. A method as claimed in claim 6 wherein semantic conflicts are resolved by user supervision.

8. A method as claimed in claim 6 wherein semantic conflicts are transformed into data relationships.

9. A method as claimed in claim 6 wherein data relationships are merged by capturing the cardinality of said relationships.

10. A method as claimed in claim 6 wherein classes are merged by subtype relationship.

11. A method as claimed in claim 6 wherein classes are merged by generalization.

12. A method as claimed in claim 6 wherein classes are merged by aggregation.

13. A method as claimed in claim 1 wherein said frame metadata model comprises a header class, attribute class, method class and constraint class.

14. A method as claimed in claim 13 wherein said header class comprises basic information representing said class identity.

15. A method as claimed in claim 13 wherein said attribute class represents the properties of a class.

16. A method as claimed in claim 13 wherein the method class represents the behaviour, active rules and/or deductive rules of a data object.

17. A method as claimed in claim 13 wherein the constraint class represents any constraints on a data object.

18. An architecture for a data warehouse comprising: a plurality of local databases including at least one relational database and at least one object-oriented database, a global schema formed from integrating the schema of said local databases, a frame metadata model for describing data in said local databases and for describing relationships between data in said at least one object oriented database and for describing any constraints derived during schema integration, a star schema for abstracting data from said local databases into a data cube for analysis, and means for querying said data cube.

19. An architecture for a data warehouse as claimed in claim 18 wherein means are provided for abstracting data from said local databases into either a relational data cube or an object-oriented data cube for enabling relational or object oriented views of said abstracted data dependent on a user's request.

20. An architecture for a data warehouse as claimed in claim 18 wherein said querying means comprises means for performing online analytical processing of said data cube.

21. An architecture for a data warehouse as claimed in claim 18 wherein said frame metadata model comprises a header class, attribute class, method class and constraint class.

22. An architecture for a data warehouse as claimed in claim 21 wherein said header class comprises basic information representing said class identity.

23. An architecture for a data warehouse as claimed in claim 21 wherein said attribute class represents the properties of a class.

24. An architecture for a data warehouse as claimed in claim 21 wherein said method class represents the behaviour, active rules and/or deductive rules of a data object.

25. An architecture for a data warehouse as claimed in claim 21 wherein said constraint class represents any constraints on a data object.

26. A data warehouse comprising a plurality of local databases including at least one relational database and at least one object-oriented database, comprising: means for abstracting data from said local databases for analysis and means for querying said abstracted data, wherein said means for abstracting data is able to present said abstracted data for analysis in either relational or object-oriented views at the request of a user.

27. A method for integrating the schema of a plurality of local databases wherein said local database schemas are integrated in pairs, the integration of a pair of local database schemas including the resolving of semantic conflicts and merging of classes and relationships, and wherein a frame metadata model is established for describing the contents of said integrated local databases including any constraints established during said schema integration.

28. A method as claimed in claim 27 wherein semantic conflicts are resolved by user supervision.

29. A method as claimed in claim 27 wherein semantic conflicts are transformed into data relationships.

30. A method as claimed in claim 27 wherein data relationships are merged by capturing the cardinality of said relationships.

31. A method as claimed in claim 27 wherein classes are merged by subtype relationship.

32. A method as claimed in claim 27 wherein classes are merged by generalization.

33. A method as claimed in claim 27 wherein classes are merged by aggregation.
